(19) United States
(12) Patent Application Publication
(10) Pub. No.: US 2012/0217419 A1
(43) Pub. Date: Aug. 30, 2012

(54) CORE-SHELL NANOPHOSPHORS FOR RADIATION STORAGE AND METHODS

(75) Inventors: Hans Riesen, Hughes (AU); Tracy Massil, Duffy (AU); Zhiqiang Liu, Watson (AU)

(73) Assignee: DOSIMETRY & IMAGING PTY LTD., Roseville (AU)

(21) Appl. No.: 13/508,116

(22) PCT Filed: Nov. 5, 2010
(86) PCT No.: PCT/AU10/01476

§ 371 Date: May 4, 2012

(30) Foreign Application Priority Data
Nov. 6, 2009 (AU) 2009905433

(51) Int. Cl. G01T 1/10; B05D 5/06; C09K 11/61; C09K 11/85; B82Y 30/00; B82Y 40/00

(52) U.S. Cl. 250/473.1; 252/301.4 H; 427/157; 977/890; 977/901; 977/891; 977/900; 977/773

(57) ABSTRACT

This invention relates to a method for producing a core-shell nanophosphor for use in radiation storage comprising: a) preparing a nanoscale metal halide core; b) coating the nanoscale metal halide core with at least one shell which is activated by a rare earth metal; and c) forming a core-shell nanophosphor. This invention also relates to a core-shell nanophosphor comprising a substrate core and at least one shell that is sensitive to ionizing radiation, neutrons, electrons or UV radiation. This invention also relates to a radiation image storage panel, a radiation monitoring apparatus and a use of the core-shell nanophosphor according to this invention.

### FIELD OF THE INVENTION

This invention relates to core-shell nanophosphors. In particular, this invention relates to core-shell nanophosphor particles which function as radiation storage phosphors and in particular X-ray radiation storage phosphors. This invention also relates to methods of production of core-shell nanophosphors. This invention also relates to methods of detecting and monitoring radiation levels in a subject or a part thereof using the core-shell nanophosphors of this invention. This invention also relates to methods of imaging a subject or part thereof using the core-shell nanophosphors of this invention.

The core-shell nanophosphors may also be used in an apparatus for detecting and monitoring radiation. In particular, the core-shell nanophosphors may be used in an apparatus for detecting and monitoring radiation which may be used on a subject or part thereof where the subject may be a mammal. The core-shell nanophosphors may also be used in an apparatus for imaging such as imaging readers.

### BACKGROUND

It should be understood that any discussion of the background art throughout this specification should in no way be considered as an admission that such background is prior art nor that such background art is widely known or forms part of the common general knowledge in the field.

X-rays have played a major role in medical and scientific imaging since their discovery in the 19^{th} century. The original technique of recording transmitted X-rays directly on photographic films is still in use where photographic emulsions are directly exposed to X-rays, resulting in latent images by the blackening of the film. However, high X-ray doses are required since silver based films are rather inefficient in the capture of X-rays.

The health risks associated with exposing the human body to high doses of X-rays have been well recognized and it is established that X-ray exposure can cause cancer. In a publication by G J Heyes, A J Mill, and M W Charles, British Journal of Radiology (2006) 79, 195-200 entitled, “Enhanced biological effectiveness of low energy X-rays and implications for the UK breast screening programme”, there is highlighted a need to reduce X-ray doses in breast screening programmes.

Accordingly, it is desirable to provide an apparatus and method to facilitate medical X-ray imaging at lower radiation doses. The screen-film method was the first major improvement over the direct silver-film exposure method. In this method, X-rays are converted to visible light by a scintillating screen and the resulting visible light is then recorded by a conventional silver-halide based emulsion film.

The phosphor materials used in the scintillating screens have to be good absorbers of X-rays and have to emit light in the wavelength region of high sensitivity of the photographic film. The presently used phosphors in these screens are based on rare earth activated materials. However, the photosensitive silver halide grains in the film are saturated with approximately four X-ray photons i.e. the dynamic range of the blackening process is very limited. Nevertheless, due to the thin film thickness, which limits scattering effects, the spatial resolution of this method is still one of the highest up to date.

FIG. 1 depicts a schematic diagram of the screen-film method where X-rays are shown as lines which are converted to visible light via a scintillation screen which comprises a film. The resolution for two imaging mediums are shown in the table as 10 line pairs/mm for x-ray film and 2.5 line pairs/mm for the computed radiography medium BaFBr_{0.85}I_{0.15}:Eu²⁺ (MD-10).

Computed radiography has gained significant momentum since it allows a reduction of the dose of radiation to as low as 18% in comparison with screen-film technology. In conventional computed radiography (CR), the latent image on an imaging plate (comprising an X-ray storage phosphor) formed by exposure to ionizing radiation, is read out by photostimulated emission using the so-called “flying-spot” method.

In the “flying-spot” method, a focused red helium-neon laser beam is scanned across the imaging plate and the resulting photostimulated emission in the blue-green region of the visible spectrum is converted into a digital signal pixel-by-pixel. In contrast to the screen-film method, CR phosphors enable a dynamic range of up to 8 orders of magnitude. However, the spatial resolution of imaging plates in CR is not yet on a par with screen-film technology due to the relatively large crystallites/grain size required in the commercially used photostimulable X-ray storage phosphor, such as BaFBr(I):Eu²⁺.

In FIG. 2, there is shown a schematic diagram of conventional computed radiography comprising an imaging phase and a subsequent readout phase by the “flying-spot” method. FIG. 2 depicts an image acquisition phase and an image reading phase. The imaging acquisition phase comprises X-ray photons contacting a storage phosphor imaging plate. The imaging reading phase comprises a laser which shines light onto the storage phosphor imaging plate which then releases an emission which is read by a detector.

Whilst there are many full-solid state digital radiology devices, the digital panels on these devices are extremely expensive when large dimensions and high resolution are required. Moreover, full solid state devices are not flexible and hence, for example, cause patient discomfort when used for oral examinations. Presently, more than 66% of radiography is still undertaken by the screen-film method; an upconversion to computed radiography does not require major instrumental upgrades.

PCT International application no. PCT/AU2005/001905 (WO2006/063409)

(NewSouth Innovations Pty Limited), entitled “RADIATION STORAGE PHOSPHOR & APPLICATIONS”, filed on 16 Dec. 2005 describes photoluminescent (photoexcitable; radioluminescent) X-ray storage phosphors (nanocrystalline alkaline earth halides activated with Sm³⁺) that allow an accumulative and repetitive readout of the latent image by photoexcitation of relatively stable Sm²⁺ centres generated from the Sm³⁺impurity ions by reduction from F-centres upon X-ray exposure.

The photoexcited luminescence is based on very narrow f-f transitions in the red region of the visible spectrum and in the near-infrared of the X-ray created Sm²⁺-centres and allows high-sensitivity and high-resolution readouts with excellent signal-to-noise ratio and high contrast. The contents of International PCT application no. PCT/AU2005/001905 (WO2006/063409) is incorporated herein by cross reference.

International PCT application no. PCT/AU2008/001 566 (WO2009/052568) (New South Innovations Pty Limited), entitled “APPARATUS AND METHOD FOR DETECTING AND MONITORING RADIATION” describes apparatus and methods for detecting radiation which may use the core-shell nanophosphors of this invention. The contents of International PCT application no. PCT/AU2008/001566 (WO2006/063409) is incorporated herein by cross reference.

Accordingly, this invention seeks to overcome the problems in the prior art by providing core-shell nanophosphors, methods of production of core-shell nanophosphors or to provide alternatives to the prior art.

### DEFINITIONS

The following part of the specification provides some definitions that may be useful in understanding the description of the present invention. These are intended as general definitions and should in no way limit the scope of this invention to those terms alone, but are put forth for a better understanding of the following description.

Unless the context requires otherwise or is specifically stated to the contrary, integers, steps, or elements of the invention recited herein as singular integers, steps or elements clearly encompass both singular and plural forms of the recited integers, steps or elements.

Throughout this specification, unless the context requires otherwise, the word “comprise”, or variations such as “comprises” or “comprising” will be understood to imply the inclusion of a stated step or element or integer or group of steps or elements or integers. Thus, in the context of this specification, the term “comprising” is used in an inclusive sense and thus should be understood as meaning “including principally, but not necessarily solely”.

Those skilled in the field will appreciate that the invention described herein is susceptible to variations and modifications other than those specifically described. It is to be understood that the invention includes all such variations and modifications. The invention also includes all of the steps, features, compositions and compounds or any two or more of said steps or features.

Throughout this specification the terms photoluminescent, photoexcitable and radioluminescent are defined to have the same meaning which is that upon exposure to ionizing radiation relatively stable optical centres are created that can be read out by standard photoluminescence that is to say by excitation at shorter wavelengths with luminescence at longer wavelengths. In this case electrons within the optical centre are directly excited by the excitation light.

Throughout this specification the terms optically stimulated luminescence (OSL) and photostimulated luminescence (PSL) refer to the same phenomenon. A PSL or OSL material yields metastable traps for electron-hole pairs upon exposure to ionizing radiation. Upon subsequent stimulation at longer wavelength, shorter wavelength luminescence occurs due to the recombination of electrons and holes. This is an indirect excitation of luminescence and distinctly different to the photoluminescence (radioluminescence) described above.

Throughout the specification, the terms nanocrystals and nanocrystalline refer to materials comprising crystallites that have at least one dimension on the nanometer scale (1-999 nm). Nanoparticles can either consist of one or more aggregated nanocrystals and the term core-shell nanophosphor refers to a luminescent/phosphorescent material comprising particles on the nanometer scale that have a core consisting of one or multiple aggregated nanocrystals with a shell with another chemical composition.

### SUMMARY OF THE INVENTION

In an embodiment, this invention relates to a method for producing a core-shell nanophosphor for use in radiation storage comprising:
a) preparing a nanoscale metal halide core;
b) coating the nanoscale metal halide core with at least one shell which is activated by a rare earth metal; and
c) forming a core-shell nanophosphor.
   The method according to this invention may further comprise the step a) of preparing the nanoscale metal halide core by chemical preparation or chemical treatment steps.

The chemical preparation in step a) may be selected from the group consisting of reverse microemulsions, solid state reactions, co-precipitation, colloidal treatment, capping, cluster formation, sol-gel, electrochemical treatment, solvothermal treatment, hydrothermal treatment, chemical vapour deposition, wet chemistry, ball milling, sputtering of thin nanocrystalline films, combustion reaction and combinations thereof. In step a), the nanoscale metal halide core may be prepared by precipitation, hydrothermal/solvothermal synthesis, or reverse microemulsions.

The metal halide core may be selected from the group consisting of CaF₂, SrF₂, BaF₂, BaFCl, BaFBr, SrFCl, SrFBr, Ba₂ClF₃, CsBr, CsF, SrMgF₄, SrAlF₅, Ba₇F₁₂C₁₂, Ba₂Mg₃F₁₀, BaMgF₄ and mixtures thereof.

The rare earth metal may be selected from the group consisting of samarium, europium and dysprosium.

The step a) of preparing the nanoscale metal, halide core may also be by physical preparation or physical treatment steps. The physical preparation or physical treatment may comprise milling, in particular using ball mills.

The method according to this invention may further comprise coating at least one rare earth activated shell on the metal halide core. The method may also comprise coating a first and a second rare earth or transition metal ion activated shell on the metal halide core. The second rare earth or metal ion activated shell may also act as an electron donor.

The first rare earth activated shell may be selected from the group consisting of a metal halide, an alkali halide, an alkaline earth halide and mixtures thereof. The second rare earth or transition metal ion activated shell may upon exposure to radiation be capable of producing a plurality of free electrons or F-centres.

The method according to this invention may further comprise a core-shell nanophosphor having a first rare earth activated shell and a second rare earth activated shell. In one embodiment, the seconds rare earth activated shell after exposure to radiation produces a plurality of electrons which are then injected into the first rare earth activated layer.

The method according to this invention may further comprise a core-shell nanophosphor comprising a core which is a metal halide, and further wherein the metal halide may be selected from the group consisting of CaF₂, SrF₂, BaF₂, BaFCl, BaFBr, SrFCl, SrFBr, Ba₂ClF₃, CsBr, CsF, SrMgF₄, SrAlF₅, Ba₇F₁₂C₁₂, Ba₂Mg₃F₁₀, BaMgF₄ and mixtures thereof.

The at least one rare earth activated shell may be selected from the group consisting of BaFCl:Sm³⁺, BaFBr:Sm³⁺, BaFCl:Sm³⁺, BaFCl₁₋ₓBrₓ:Sm³⁺, BaFCl_{1-x-y}BrₓI_{y}:Sm³⁺, SrFCl:Sm³⁺, SrFBr:Sm³⁺, SrFCl₁₋ₓBrₓ:Sm³⁺, BaFCl_{1-x-y}BrₓI_{y}:Sm³⁺, Ba₁₋ₓSrₓFCl: Sm3+, BaFCl: Sm³⁺, SrMgF₄₋ₓClₓ:Sm³⁺, SrAlF₅₋ₓClₓ:Sm³⁺, Ba₇F₁₂Cl₂:Sm³⁺, Ba₂Mg₃F₁₀:Sm³⁺, BaMgF₄:Sm³⁺, and mixtures thereof.

The core-shell nanophosphor may comprise a substrate core and at least one shell that is sensitive to ionizing radiation, neutrons, electrons or UV radiation. The core-shell nanophosphor may comprise a substrate core, wherein the substrate core may be selected from the group consisting of a metal halide, an alkali halide, an alkaline earth halide and mixtures thereof.

The core-shell nanophosphor may comprise at least one rare earth activated shell, wherein the shell may be formed from the same material as the substrate core. The at least one rare earth activated shell may be selected from the group consisting of a metal halide, an alkali halide or an alkaline earth halide and mixtures thereof.

The core-shell nanophosphor may have at least one rare earth activated shell which is selected from the group consisting of BaFCl:Sm³⁺, BaFBr:Sm³⁺, BaFCl:Sm³⁺, BaFCl₁₋ₓBrₓ:Sm³⁺, BaFCl_{1-x-y}BrₓI_{y}:Sm³⁺, SrFCl:Sm³⁺, SrFBr:Sm³⁺, SrFCl₁₋ₓBrₓ:Sm³⁺, BaFCl_{1-x-y}BrₓI_{y}:Sm³⁺, Ba₁₋ₓSrₓFCl:Sm³⁺, BaFCl:Sm³⁺, SrMgF₄₋ₓClₓ:Sm³⁺, SrAlF₅₋ₓClₓ:Sm³⁺, Ba₇F₁₂Cl₂:Sm³⁺, Ba₂Mg₃F₁₀:Sm³⁺, BaMgF₄:Sm³⁺, and mixtures thereof.

The rare earth ion which may be used in the at least one rare earth activated shell may be selected from the group consisting of Eu³⁺, Sm³⁺, Dy³⁺ and combinations thereof. In one embodiment, the rare earth ion is reduced to the +2 oxidation state upon exposure to radiation. In an example, the rare earth ion may be Sm³⁺ which is reduced upon exposure to radiation to Sm²⁺.

In another embodiment, the core-shell nanophosphor comprises at least one rare earth activated shell wherein the rare earth ion is relatively stable allowing for multiple readouts of narrow f-f photoluminescence. In another embodiment, the rare earth ion may be Sm³⁺ which may be reduced to the +2 oxidation state. It is noted that the Sm²⁺ rare earth ion is relatively stable allowing for multiple readouts of narrow f-f photoluminescence.

This invention also relates to a core-shell nanophosphor which is produced by the process of this invention.

In another embodiment of this invention, there is provided a radiation image storage panel comprising the core-shell nanophosphor. In another embodiment of this invention, there is provided a radiation monitoring apparatus comprising the core-shell nanophosphor according to this invention. In another embodiment of this invention, there is provided a use of the core-shell nanophosphor according to this invention in monitoring doses of radiation therapy.

In another embodiment of this invention, there is provided a use of the core-shell nanophosphor according to this invention in imaging plates for scientific and medical imaging.

In another aspect, this invention relates to a use of the core-shell nanophosphor according to this invention for energy sensitive dosimetry and radiation detection. A mixture of at least two different core-shell nanoparticles is exposed to ionizing radiation. Since the two types of nanoparticles have different energy dependences of their radiation storage efficiency, it is possible to calculate the (average) energy of the ionizing radiation by measuring the ratio of the intensities of the induced photoluminescence or photostimulated emission of the two variants of nanoparticles.

In another aspect, this invention relates to shell activated core-shell nanoparticles of metal halides. The core-shell nanoparticles may be made to be very sensitive to ionizing radiation. The size of the core-shell nanoparticle can vary from 1 nm to 900 nm and may be tailored and optimized for various applications.

Importantly, due to the very small grain/particle size the core-shell nanophosphors, the core-shell nanophosphors have the potential to offer the dynamic range and sensitivity of X-ray storage phosphors combined with the high resolution of conventional screen-film X-ray imaging. The photoluminescent X-ray storage phosphors described in International PCT application no. PCT/AU2005/001905 (WO2006/063409) require different read out methods since they are based on narrow photoluminescence (emission at longer wavelength than photoexcitation light) with relatively long lifetimes (2 ms) rather than the broad, short-lived photostimulated emission (emission at shorter wavelength than photostimulation light) used in conventional computed radiography.

### BRIEF DESCRIPTION OF THE DRAWINGS

FIG. 1 depicts a schematic diagram of a screen-film method of the prior art;

FIG. 2 depicts a schematic diagram of a prior art computed radiography method;

FIG. 3 depicts a schematic diagram for a method of preparation of a core-shell nanophosphor particle having one shell in accordance with a first embodiment of this invention; and

FIG. 4 depicts a schematic diagram for the method of preparation of a core-shell nanophosphor particle having two shells in accordance with a second embodiment of this invention;

FIG. 5a and FIG. 5b are graphical representations of data resulting from an evaluation of the modulation transfer function (MTF) for the core-shell BaFCl/BaFCl:Sm³⁺ photoluminescent X-ray storage phosphor (solid line in picture on right);

FIG. 6 is a representation of reverse microemulsions as used in this invention;

FIG. 7 depicts the luminescence spectrum of the nanocrystalline core-shell photoluminescent X-ray storage phosphor BaFCl/BaFCl:Sm³⁺ before and after exposure to ionizing radiation;

FIG. 8 depicts photoluminescence in the region of the ⁵D₀→⁷F₀ transitions of an energy selective photoluminescent storage phosphor (SrF₂/SrFCl:Sm²⁺ and SrF₂/BaFCl:Sm²⁺) where the ratio of the two transitions allows the determination of the average energy;

FIG. 9 depicts the powder X-ray diffraction of BaF₂/BaFCl:Sm³⁺ core-shell nanoparticles; and

FIG. 10 depicts a transmission electron microscopy graph of BaFCl/BaFCl:Sm³⁺ nanocrystals.

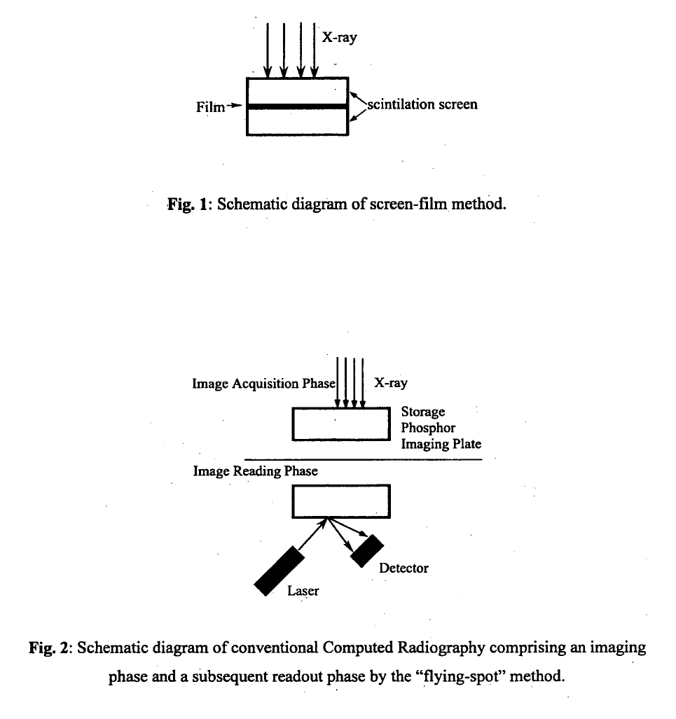

### DESCRIPTION OF THE PREFERRED EMBODIMENT(S)

The following is a description of the preferred embodiments of the invention. It should be appreciated that the following description of the preferred embodiments is not intended to limit the generality and scope of the claims.

In FIG. 3, there is shown an embodiment of this invention which is depicted as a schematic diagram for a method of preparation of a core-shell nanophosphor particle having one shell in accordance with a first embodiment of this invention. In a first step, a core is produced on the nanoscale by a range of chemical methods e.g. co-precipitation, solvothermal, hydrothermal treatment or chemical vapour deposition. In a second step, the nanoscale core is coated with a shell that is activated by a rare earth metal such as samarium in the 3+ oxidation state. This second step can be conducted by a wide range of chemical methods such as solid state reaction assisted by milling, hydrothermal or solvothermal treatment and by wet chemistry in general.

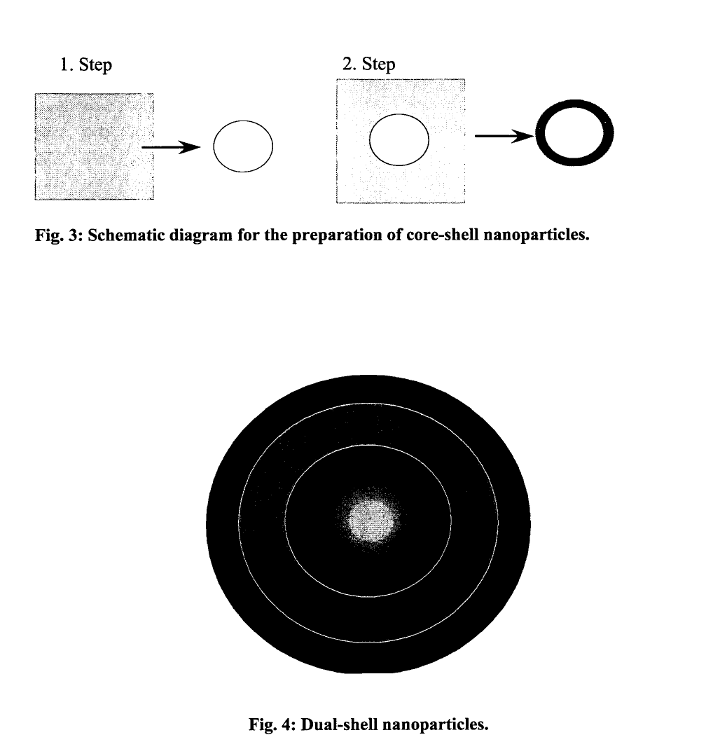

In FIG. 4, there is shown another embodiment showing dual shell nanoparticles where in this embodiment of this invention, instead of applying only one shell that is activated by a rare earth metal such as samarium in the 3+ oxidation state (Sm³⁺) there is also provided a second shell using the same or similar method of production steps as for the production of the first shell as described earlier. The second shell acts as an electron donor and is capable of injecting electrons into the first shell upon exposure to ionizing radiation. The electrons injected into the inner shell are then used for the reduction of the rare earth metal such as for example from Sm³⁺ to Sm²⁺.

A significant advantage of the storage phosphors and associated reader apparatus is the X-ray storage mechanism. In the X ray storage mechanism, the Sm²⁺ centres (formed by ionizing radiation inducing reduction from Sm³⁺) are very stable (although they can be reversibly bleached out by a two-step photon ionization at higher light powers) and thus their photoluminescence can be readout many times, yielding a better signal-to-noise ratio compared to photostimulable phosphors where the stored energy is released upon photostimulation (one readout per pixel only).

This allows repetitive and parallel readout of a few megapixels by CCD or CMOS cameras. Moreover, in contrast to the broad photostimulated 4f⁶5d→4f⁷ emission of the BaFBr (I):Eu²⁺ phosphor, the photoluminescence of our photoluminescent phosphors is extremely narrow since it is based on transitions within the f-electron shell.

This facilitates a far higher contrast and discrimination between excitation and emission light. Prior art phosphors (BaFBr_{0.85}I_{0.15}:Eu²⁺) have limited spatial resolution due to scattering effects caused by the relatively large crystallites that have to be employed to facilitate their sensitivity. In contrast, the core-shell nanophosphors of this invention may be based on nanoparticles which may range from 50 nm to 150 nm in diameter, 60 nm to 140 nm in diameter, 70 nm to 130 nm in diameter, 80 nm to 120 nm in diameter, 90 nm to 110 nm in diameter, or more typically about 100 nm in diameter (average volume weighted diameter). Hence a higher packing density is achieved and scattering effects are less pronounced allowing higher spatial resolution.

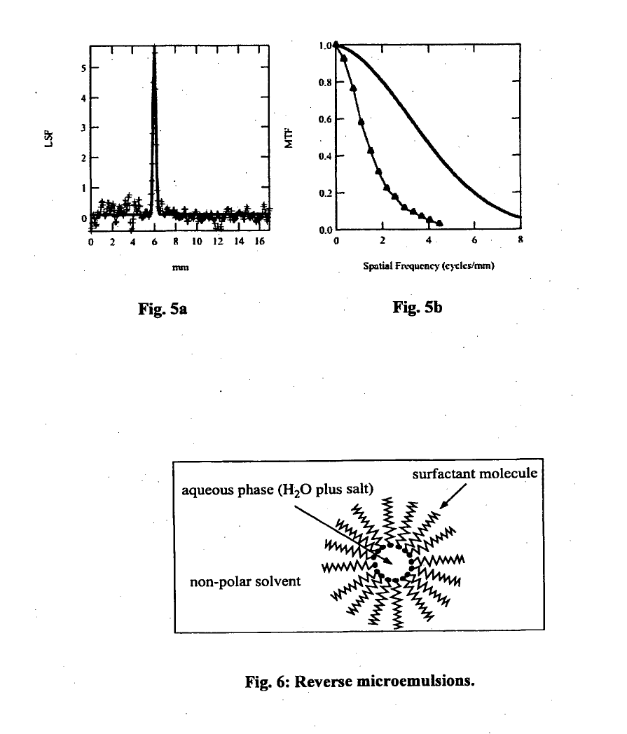

The far higher contrast and discrimination of the core-shell nanophosphors of this invention is demonstrated by data shown in FIG. 5. FIG. 5 demonstrates an evaluation of the modulation transfer function (MTF). The data in FIG. 5 was obtained by imaging a steel edge by one standard oral examination dose (ca 1 mGy surface dose) at 65 kV and 7 mA X-ray tube voltage and current.

The steel edge was sandwiched between the imaging plate and a 20-mm Perspex plate (to mimic scattering by tissue) and the X-ray camera was 150 mm above the Perspex. As can be seen from this evaluation, the MTF is significantly better than for state-of-the-art CR systems (e.g. Kodak CR 9000 with CR-GP imaging plate). The latter CR system is based on the photostimulable storage phosphor systems.

A steel edge on top of an imaging plate was imaged by one standard oral examination dose (ca 5 μGy body dose) through 20 mm of Perspex. The readout was conducted by a prototype 2D reader developed. The MTF for a Kodak CR9000 reader with CR-GP imaging plates is shown for comparison (solid triangles connected by solid line). The picture on the left shows the line spread function as obtained by differentiation of the edge spread function ESF.

Core-shell nanophosphor particles are photoluminescence based X-ray storage phosphors. The core-shell nanophosphors of this invention are more sensitive than prior art phosphors since it is postulated that the activated shell can accommodate many more defects and hence can provide electrons for the ionizing radiation induced reduction of samarium (III). Also the ionizing radiation does not have to penetrate a particle that strongly attenuates the ionizing radiation. Rather, the effect occurs on the surface i.e. shell.

A mixture of core-shell nanophosphor particles (e.g. BaFCl/BaFCl:Sm³⁺ BaFCl/SrFCl:Sm³⁺) or nanophosphor particles with a mixed shell may also be used for energy-sensitive radiation detection. The radiation detection occurs on the basis of the different energy dependence of the Sm³⁺→Sm²⁺ conversion in the two (or multiple environments). The measurement of the ratio of the Sm²⁺ photoluminescence at the two (or multiple) wavelengths corresponding to different environments allows the determination of the energy or the average energy of the monochromatic or multichromatic ionizing radiation, respectively.

### Preparation of Core-Shell And Core-Dual Shell Nanophosphor Particles

In one embodiment of this invention, the core of the nanophosphor particles may be prepared by a range of methods including but not limited to hydrothermal/solvothermal synthesis (e.g. where solutions are exposed at high temperatures and high pressures in an autoclave), reverse microemulsions (e.g. where reverse micelles in an-oily phase restrict and control dimensions of the aqueous phase i.e microscopic “reaction vessels” are provided), co-precipitation (e.g. SrF₂ and BaF₂ nanoparticles can be synthesized by co-precipitation of the chloride salt with ammonia fluoride solutions and with various ethanol-water mixtures), and (mechanochemical) solid state reactions (e.g. milling BaF₂ and BaCl₂:Sm³⁺ nanoparticles).

In FIG. 6, for example, reverse micelles may be readily produced by using polyoxyethylene nonyl phenol (Igepal CO-520), methanol and water. The Igepal, methanol and water act as the surfactant, co-surfactant and polar phase, respectively. The first polar aqueous phase contains the alkaline earth salt and the second phase contains the fluoride salt. The two reverse micelles are stirred and then rapidly mixed to yield the powder on the nanoscale. The particle size and its uniformity can be optimized by employing a range of surfactant/polar phase ratios. The micelles define the dimensions of a “chemical reaction vessel” and thus limit and determine the size of the nanoparticles.

In another example, highly uniform particle sizes of Ba₂ClF₃ may be obtained through solvothermal treatment by changing the ratio of water to oleic acid. The nanoparticles formed from the solvothermal treatment may then be further treated in a second step with the hydrothermal/solvothermal method or by solid state chemistry in a ball mill. As a further example, when BaF₂ nanoparticles are milled with BaCl₂:Sm³⁺, BaF₂/BaFCl:Sm³⁺ core-shell nanophosphor particles are formed as can be demonstrated with high resolution electron microscopy and powder x-ray diffraction.

A list of core and shell materials which may be used for this invention is shown in Table 1 below. Table 1 lists 225 examples of suitable core-shell combinations of this invention. The core particles may be coated by a range of shell materials, although it will be appreciated that not all combinations may be formed due to lattice parameters. Also, the sensitivity of the phosphor may depend on the relative dimensions of the core and shell.

TABLE 1

| Core | Shell |
|---|---|
| 1. CaF₂ | 1. BaFCl: Sm³⁺ |
| 2. SrF₂ | 2. BaFBr: Sm³⁺ |
| 3. BaF₂ | 3. BaFCl₁₋ₓBrₓ: Sm³⁺ |
| 4. BaFCl | 4. BaFCl_{1-x-y}BrₓI_{y}: Sm³⁺ |
| 5. BaFBr | 5. SrFCl: Sm³⁺ |
| 6. SrFCl | 6. SrFBr: Sm³⁺ |
| 7. SrFBr | 7. SrFCl₁₋ₓBrₓ: Sm³⁺ |
| 8. Ba₂ClF₃ | 8. BaFCl_{1-x-y}BrₓI_{y}: Sm³⁺ |
| 9. CsBr | 9. Ba₁₋ₓSrₓFCl: Sm³⁺ |
| 10. CsF | 10. BaFCl: Sm³⁺, SrFCl: Sm³⁺ |
| 11. SrMgF₄ | 11. SrMgF₄₋ₓClₓ: Sm³⁺ |
| 12. SrAlF₅ | 12. SrAlF₅₋ₓClₓ: Sm³⁺ |
| 13. Ba₇F₁₂Cl₂ | 13. Ba₇F₁₂Cl₂: Sm³⁺ |
| 14. Ba₂Mg₃F₁₀ | 14. Ba₂Mg₃F₁₀: Sm³⁺ |
| 15. BaMgF₄ | 15. BaMgF₄: Sm³⁺ |

### EXAMPLES OF METHODS OF PREPARATION OF CORE-SHELL NANOPARTICLES

### 1. Embodiment: Preparation In Situ

### Example 1

### BaFCl/BaFCl:Sm³⁺ Core-Shell Nanophosphor Particles

1. Prepare aqueous solutions of 0.4 M BaCl₂2H₂O (48.85 g in 500 mL of H₂O and 2 drops HCl 36%), 0.2 M NH₄F (1.48 g in 200 mL H₂O) and 1 mg/mL solution of SmCl₃.6H₂O in advance and keep in a water bath at 23° C.
2. Into a 50 mL plastic centrifuge tube place 25 ml 0.4 M BaCl1₂.2H₂O, 600 p.1, of a 1 mg/ml solution of SmCl₃.6H₂O and 150 μL HCl (36%).
3. Seal the centrifuge tube, and place in the water bath at 23° C.
4. Add 25 mL of 0.2 M NH₄F to the barium and samarium solution. A white precipitate should immediately start to form.
5. Allow the mixture to precipitate for a further 10min at 23° C.
6. Separate the precipitate from the solution by centrifugation for 10 minutes and then decant.
7. Add 10 drops of the solution back to the precipitate,
8. Place the precipitate in the centrifuge tubes in a suitable glass container and allow it to dry at 65° C. for approximately 24 hrs.
9. For preparation of a powder, grind the precipitate in a mortar and pestle to yield phosphor BaFCl/BaFCl:Sm³⁺ as a white powder, 0.79 g.
   This preparation procedure may be modified to synthesize a wide range of core-shell nanophosphor particles. In particular, the first step produces a core on the nanoscale and then in the second step, an activated shell is formed.

### Example 2

### Synthesis of SrFCl/SrFCl:Sm³⁺

In this example, a mixture of 0.2 g SrF₂, 50 mL 0.4 M SrCl₂.6H₂O, 300 μL 36% HCl and 24004 μmg/mL SmCl₃.6H₂O were added into a plastic centrifuge tube. The centrifuge tube was then sealed, and shaken quickly. Then, the mixture was centrifuged for 12 minutes and the solution was decanted off. However, 2500 μL of the solution was then added back to the precipitate in the centrifuge tube. The centrifuge tube with the precipitate and 2500 μL solution were then dried in an oven at a temperature of 65° C., where the precipitate is cooled and ground to yield the SrFCl/SrFCl:Sm³⁺ as a white powder having a yield of 0.30 g.

### Example 3

### Synthesis of BaₓSr₁₋ₓFCl/Sm³⁺

In this example, a mixture of 0.2 g SrF₂, 50 mL 0.4 M BaCl₂.6H₂O, 300 μL 36% HCl and 2400 μL 1 mg/mL SmCl₃.6H₂O were added into a plastic centrifuge tube. The centrifuge tube was then sealed, and shaken quickly. Then, the mixture was centrifuged for 12 minutes and the solution was decanted off. However, 2000 μL of the solution was then added back to the precipitate in the centrifuge tube. The centrifuge tube with the precipitate and 2000 μL solution were then dried in an oven at the temperature of 65° C., where the dried precipitate is then cooled and grinded to yield the BaₓSr₁₋ₓFCl/Sm³⁺ as a white powder. Yield: 0.37 g.

Example 4: Preparation of BaFC1/BaFCl:Sm³⁺ core-shell nanophosphor

In a further preferred embodiment of this invention, there is now described an example of a method of preparation of BaFC1/BaFCI:Sm³⁺ core-shell nanophosphor in two separate steps.

### 1^{st} Step

1. Aqueous solutions of 0.4M BaCl₂.2H₂O (48.85 g in 500 ml of H₂O and 2 drops HCl 36%), 0.2M NH₄F (1.48 g in 200 mL H₂O), and 1 mg/mL solution of SmCl₃.6H₂O are prepared and stored in a water bath at 23° C.
2. 25 mL of the 0.4 M BaCl₂.2H₂O solution is then placed into a 50 mL plastic centrifuge tube, together with 600 gL of the 1 mg/mL solution of SmCl₃.6H₂O and 150 ml of HCl (36%).
3. The centrifuge tube is sealed and placed in a water bath at 23° C.
4. Add 25 mL of 0.2M NH₄F to the barium and samarium solution in the plastic centrifuge tube where a white precipitate is formed.
5. Allow the barium and samarium solution to precipitate for a further 10 min at 23° C.
6. Separate the precipitate from the barium and samarium solution by centrifugation for 10 minutes and then decant.
7. Wash precipitate several times with 20-40 mL of water and centrifuge in between.
8. Decant water and dry powder in oven at ca. 65 degrees.

### 2nd Step

1. Prepare a suspension of BaFCl nanoparticles (ca. 0.7 g in 40 mL water) by wet grinding/milling in 25 mL of 0.4 M BaCl₂, 600 _{μL of a} 1 mg/mL solution of SmCl₃.6H₂O and 150 μl HCl (36%).
2. The suspension is then rigorously shaken and/or sonicated.
3. The suspension is then centrifuged and natant liquor is thereafter decanted.
4. After decanting, 10-20 drops of fresh natant liquor is then added back to the suspension.
5. The suspension is then dried in an oven at 65° C. to form a precipitate.
6. In order to prepare a powder, the precipitate is ground in a mortar and pestle to yield a core-shell nanophosphor BaFCl/BaFCl:Sm³⁺ which is in the form of a white powder.
   As mentioned previously, FIG. 5a and FIG. 5b provides data based on an evaluation of the modulation transfer function (MTF) for the core-shell BaFCl/BaFCl:Sm³⁺ photoluminescent X-ray storage phosphor (solid line in picture on right).

Further, the data shown in FIGS. 5a and 5b demonstrates the higher contrast and discrimination of the core-shell nanophosphors of this invention, in particular BaFCl/BaFCl:Sm³⁺.

The data in FIGS. 5a and 5b was obtained by imaging a steel edge by one standard oral examination dose (ca 1 mGy surface dose) at 65 kV and 7 mA X-ray tube voltage and current. The steel edge was sandwiched between the imaging plate and a 20-mm Perspex plate (to mimic scattering by tissue) and the X-ray camera was 150 mm above the Perspex. As can be seen from FIGS. 5a and 5b, the MTF is significantly better than for prior art CR systems (e.g. Kodak CR 9000 with CR-GP imaging plate). The prior art CR system is based on the photostimulable storage phosphor systems.

In FIG. 5a and FIG. 5b, a steel edge on top of an imaging plate was imaged by one standard oral examination dose (ca 5 μGy body dose) through 20 mm of Perspex. The readout was conducted by a prototype 2D reader. The MTF for a Kodak CR9000 reader with CR-GP imaging plates is shown for comparison (solid triangles connected by solid line). The picture on the left shows the line spread function as obtained by differentiation of the edge spread function ESF.

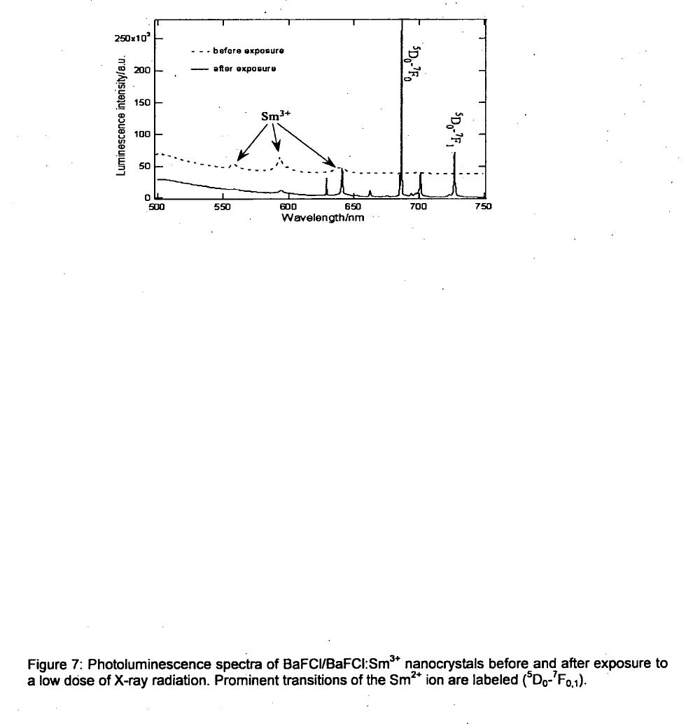

In FIG. 7, there is shown the luminescence spectrum of the nanocrystalline core-shell photoluminescent X-ray storage phosphor BaFCl/BaF'Cl:Sm³⁺ before and after exposure to a low dose of X-ray radiation. The prominent transitions of the Sm²⁺ ion are labelled in FIG. 7 as (⁵D₀-⁷F_{0,1}).

In FIG. 8, there is shown photoluminescence in the region of the ⁵D₀→⁷F₀ transitions of an energy selective photoluminescent storage phosphor (SrF₂/SrFCl:Sm²⁺ and SrF₂/BaFCI:Sm²⁺) where the intensity ratio of the two intense transitions can be used to determine the average energy of the ionizing radiation in energy sensitive dosimetry. This is done based on the predetermined energy dependence of the two phases and hence the intensity ratio provides the average energy. Similar methods are used for the wavelength determination in dual photodiode wavemeters and would be well known to the skilled person in the field.

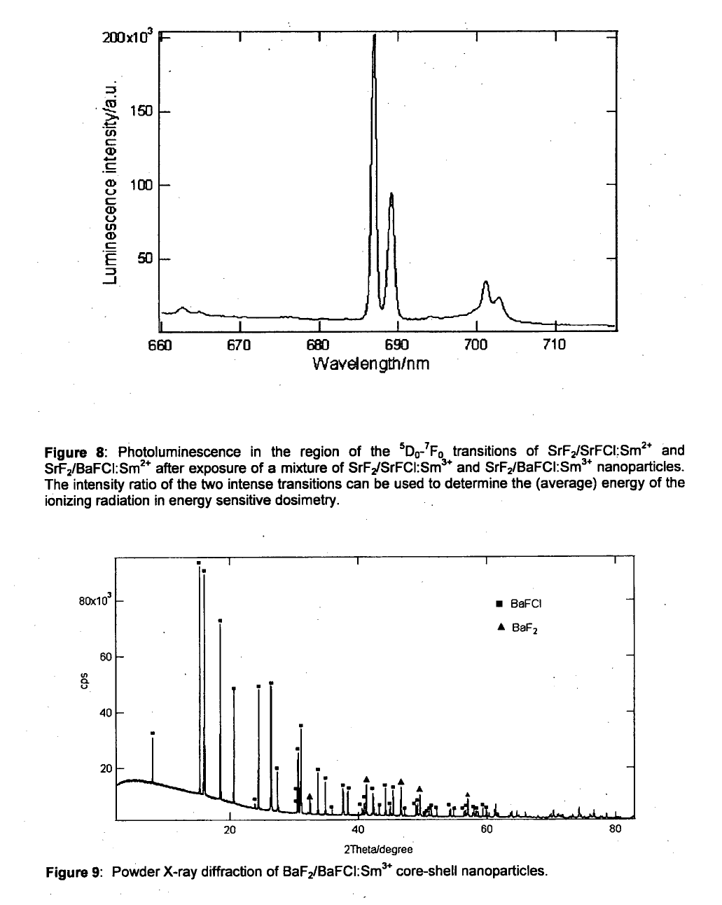

In FIG. 9, there is shown the powder X-ray diffraction of BaF₂/BaFCl:Sm³⁺ core-shell nanoparticles.

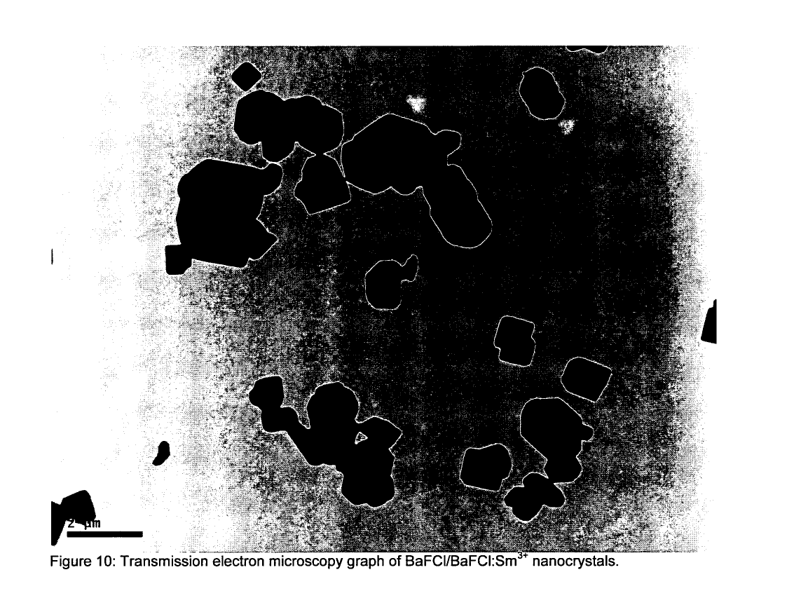

In FIG. 10, there is shown a transmission electron microscopy graph of BaFCl/BaFCl:Sm³⁺ nanocrystals.

It will be appreciated that FIGS. 7 to 10 demonstrate the improved properties of core-shell nanoparticles of the present invention over previously known phosphors. In particular, it is noted that the core-shell nanophosphors show much higher sensitivity of core-shell nanoparticles in comparison with nanoparticles with uniform rare earth ion distribution.

The advantages of the core-shell nanoparticles of this invention is that the core-shell nanoparticles can be used as photoluminescent X-ray storage phosphors which has far greater sensitivity than the currently used photo stimulable materials in computed radiography.

It will be appreciated by a skilled person that the process of this invention can be modified to synthesize a wide range of core-shell nanoparticles. In particular, the first step produces a core on the nanoscale and then in a second step the activated shell is created.

1. A method for producing a core-shell nanophosphor for use in radiation storage, comprising:
a) preparing a nanoscale metal halide core;
b) coating the nanoscale metal halide core with at least one shell which is activated by a rare earth metal; and
c) forming a core-shell nanophosphor.

2. A method according to claim 1, wherein the step a) of preparing the nanoscale metal halide core is by chemical preparation or chemical treatment steps.

3. A method according to claim 2, wherein the chemical preparation is selected from the group consisting of reverse microemulsions, solid state reactions, co-precipitation, colloidal treatment, capping, cluster formation, sol-gel, electrochemical treatment, solvothermal treatment, hydrothermal treatment, chemical vapour deposition, wet chemistry, ball milling and combinations thereof.

4. A method according to claim 1, wherein in step a) the nanoscale metal halide core is prepared by precipitation, hydrothermal/solvothermal synthesis, or reverse microemulsions.

5. A method according to claim 1, wherein the metal halide core is selected from the group consisting of CaF₂, SrF₂, BaF₂, BaFCl, BaFBr, SrFCl, SrFBr, Ba₂ClF₃, CsBr, CsF, SrMgF₄, SrAlF₅, Ba₇F₁₂Cl₂, Ba₂Mg₃F ₁₀, BaMgF₄ and mixtures thereof.

6. A method according to claim 1, wherein the rare earth metal is selected from the group consisting of samarium, europium and dysprosium.

7. A method according to claim 1, wherein the step a) of preparing the nanoscale metal halide core is by physical preparation or physical treatment steps.

8. A method according to claim 7, wherein the physical preparation is milling.

9. A method according to claim 1, wherein there is one or more rare earth activated shells coated on the metal halide core.

10. A method according to claim 9, wherein there is a first and a second rare earth activated shell where the second rare earth or transition metal ion activated shell acts as an electron donor.

11. A method according to claim 10, wherein the second rare earth or transition metal ion activated shell is selected from the group consisting of a metal halide, an alkali halide, an alkaline earth halide and mixtures thereof.

12. A method according to claim 10, wherein the second rare earth or transition metal ion activated shell upon exposure to radiation is capable of producing a plurality of free electrons or F-centres.

13. A method according to claim 12, wherein the second rare earth or transition metal ion activated shell after exposure to radiation produces a plurality of electrons which are then injected into the rare earth activated layer.

14. A method according to claim 1, wherein the metal halide is selected from the group consisting of CaF₂, SrF₂, BaF₂, BaFCl, BaFBr, SrFCl, SrFBr, Ba₂ClF₃, CsBr, CsF, SrMgF₄, SrAlF₅, Ba₇F₁₂Cl₂, Ba₂Mg₃F₁₀, BaMgF₄ and mixtures thereof.

15. A method according to claim 1, wherein the at least one rare earth activated shell is selected from the group consisting of BaFCl:Sm³⁺, BaFBr:Sm³⁺, BaFCl:Sm³⁺, BaFCl₁₋ₓBrₓ:Sm³⁺, BaFCl_{1-x-y}BrₓI_{y}:Sm³⁺, SrFCl:Sm³⁺, SrFBr:Sm³⁺, SrFCl₁₋ₓBrₓ:Sm³⁺, BaFCl_{1-x-y}BrₓI_{y}:Sm³⁺, Ba₁₋ₓSrₓFCl:Sm³⁺, BaFCl:Sm³⁺, SrMgF₄₋ₓClₓ:Sm³⁺, SrAlF₅₋ₓClₓ:Sm³⁺, Ba₇F₁₂Cl₂:Sm³⁺, Ba₂Mg₃F₁₀:Sm³⁺, BaMgF₄:Sm³⁺, and mixtures thereof.

16. A method according to claim 1, wherein the nanophosphor is selected from the group consisting of BaFCl/BaFCl:Sm³⁺, SrFCl/SrFCl:Sm³⁺, and BaₓSr₁₋ₓ FCl:Sm³⁺.

17. A core-shell nanophosphor comprising a substrate core and at least one shell that is sensitive to ionizing radiation, neutrons, electrons or UV radiation.

18. The core-shell nanophosphor of claim 17, wherein the substrate core is selected from the group consisting of a metal halide, an alkali halide, an alkaline earth halide and mixtures thereof.

19. The core-shell nanophosphor of claim 17, wherein the shell can be formed from the same material as the substrate core except that the shell material is activated by at least one rare earth ion.

20. The core-shell nanophosphor of claim 17, wherein the at least one shell is selected from the group consisting of a metal halide, an alkali halide, Of an alkaline earth halide and mixtures thereof.

21. The core-shell nanophosphor according to any one of claim 17, wherein the at least one rare earth activated shell is selected from the group consisting of BaFCl:Sm³⁺, BaFBr:Sm³⁺, BaFCl:Sm³⁺, BaFCl₁₋ₓBrₓ:Sm³⁺, BaFCl₁₋ₓ-_{y}BrₓI_{y}:Sm³⁺, SrFCl:Sm³⁺, SrFBr:Sm³⁺, SrFCl₁₋ₓBrₓ:Sm³⁺, BaFCl_{1-x-y}BrₓI_{y}:Sm³⁺, Ba₁₋ₓSrₓFCl:Sm³⁺, BaFCl:Sm³⁺, SrMgF₄₋ₓClₓ:Sm³⁺, SrAlF₅₋ₓClₓ:Sm³⁺, Ba₇F₁₂Cl₂:Sm³⁺, Ba₂Mg₃F₁₀:Sm³⁺, BaMgF₄:Sm³⁺, and mixtures thereof.

22. The core-shell nanophosphor according to claim 19, wherein the rare earth ion is selected from the group consisting of Eu³⁺, Sm³⁺, Dy³⁺ and combinations thereof.

23. The core-shell nanophosphor according to claim 22, wherein the rare earth ion is Sm³⁺.

24. The core-shell nanophosphor according to claim 23, wherein the Sm³⁺ rare earth ion is reduced to the +2 oxidation state upon exposure to radiation.

25. The core-shell nanophosphor according to claim 24, wherein after the Sm³⁺ rare earth ion is reduced to the +2 oxidation state, the Sm²⁺ rare earth ion is relatively stable allowing for multiple read outs of narrow f-f photoluminescence.

26. The core-shell nanophosphor produced by the process of claim 1.

27. A radiation image storage panel comprising the core-shell nanophosphor according to claim 17.

28. A radiation monitoring apparatus comprising the core-shell nanophosphor according to claim 17.

29. Use of A method for monitoring doses of radiation therapy comprising using the core-shell nanophosphor according to claim 17.

30. The method according to claim 29, wherein the monitoring is for personal radiation monitoring.

31. A method for imaging plates for scientific and medical imaging comprising using the core-shell nanophosphor according to claim 17.

32. A method for energy sensitive dosimetry and radiation detection the core-shell nanophosphor according to claim 17.
